(19) United States
(12) Patent Application Publication
(10) Pub. No.: US 2025/0111674 A1
(43) Pub. Date: Apr. 3, 2025

(54) Summarizing Events Over a Time Period

(71) Applicant: Google LLC, Mountain View, CA (US)

(72) Inventors: Yuan Li, Los Altos, CA (US); Indu Ramamurthi, Los Altos, CA (US); Ryan Kam Wang Tai, Sunnyvale, CA (US)

(73) Assignee: Google LLC, Mountain View, CA (US)

(21) Appl. No.: 18/420,466

(22) Filed: Jan. 23, 2024

Related U.S. Application Data
(60) Provisional application No. 63/587,588, filed on Oct. 3, 2023.
(60) Provisional application No. 63/587,702, filed on Oct. 3, 2023.

(51) Int. Cl. G06V 20/40; G06F 40/40; G11B 27/031

(52) U.S. Cl. CPC G06V 20/47; G06F 40/40; G06V 20/44; G11B 27/031

(57) ABSTRACT

This document describes systems and techniques for implementing event summarization over a period of time. A request is received to create an event summarization that includes details associated with the event summarization. The systems and techniques identify at least one image relevant to the event summarization based on the details associated with the event summarization. At least one of the identified images is selected that is relevant to the event summarization. The selected images are arranged based on how they will be included in the event summarization. A video summary is created that represents the event summarization and includes the arrangement of the selected images.

### BACKGROUND

Camera systems provide a variety of benefits by capturing images of objects and activities within the camera's field of view. The captured images may be surrounding a home, business, or other area depending on the location and orientation of the camera. The captured images may provide security and monitoring activities for a user of the camera system.

Some existing cameras can detect a few objects in the captured images, such as people, vehicles, or animals. However, these existing cameras are typically limited to identifying this small set of objects. This prevents users from detecting more sophisticated objects through their camera and prevents them from identifying more interesting situations or activities captured by the camera.

### SUMMARY

This document describes systems and techniques for summarizing events that occur over a period of time, such as a few hours, a day, a week, and the like. In some aspects, these systems and techniques may summarize events by creating a timelapse image sequence that summarizes a particular period of time in chronological order. In other situations, the systems and techniques may summarize events based on a particular theme or topic by creating a highlight image sequence that is not necessarily in chronological order. For example, the systems and techniques may receive a request using a natural language phrase spoken by a user or other information received from a system. The received request is analyzed and, based on the analysis, a timelapse image sequence, highlight image sequence, or other image sequence is created that satisfies the received request. In some aspects, the timelapse image sequence, highlight image sequence, or other image sequence is a video created using multiple images captured by one or more cameras or other image capture devices. The timelapse image sequence, highlight image sequence, or other image sequence may be communicated to the user or system generating the request.

Allowing a user to request an event summarization using natural language input simplifies the process for the user. Instead of requiring the user to remember specific phrases and exact terms, the user merely speaks in their own language to describe the desired event summarization. The systems and techniques described herein process the user's natural language input, determine the user's desired event summarization, and create that event summarization. Thus, the user can quickly and easily initiate the creation of an event summarization without having to learn specific phrases or techniques. Additionally, the described systems and techniques allow the user to automatically create a desired event summarization. Instead of manually searching through many images or video clips to find desired event information, the user merely requests an event summarization. The described systems and techniques automatically search through images to select the best images for the event summarization, then create a video summary representing the summarized events.

For example, a method comprises receiving a request to create an event summarization where the request includes details associated with the event summarization. The method further comprises identifying at least one image relevant to the event summarization based on the details associated with the event summarization. The method also selects at least one of the identified images relevant to the event summarization. The method further arranges the selected images to be included in the event summarization. The method also creates a video summary representing the event summarization where the video summary includes the arrangement of the selected images.

In another example, an apparatus includes an image processing system configured to receive images from an image capture device. An event summarization system is coupled to the image processing system and configured to receive a request to create an event summarization where the request includes details associated with the event summarization. The event summarization system also identifies at least one image relevant to the event summarization based on the details associated with the event summarization. The event summarization system further selects at least one of the identified images relevant to the event summarization. The event summarization system also arranges the selected images based on how they will be included in the event summarization. The event summarization system creates a video summary representing the event summarization where the video summary includes the arrangement of the selected images.

This document also describes other methods, configurations, and systems for summarizing events over a period of time. Optional features of one aspect, such as the apparatus or method described above, may be combined with other aspects.

This summary is provided to introduce simplified concepts for summarizing events over a period of time, which is further described below in the detailed description and drawings. This summary is not intended to identify essential features of the claimed subject matter, nor is it intended for use in determining the scope of the claimed subject matter.

### BRIEF DESCRIPTION OF THE DRAWINGS

The details of one or more aspects of event summarization systems are described in this document with reference to the following drawings. The same numbers are used throughout multiple drawings to reference like features and components.

FIG. 1 illustrates an example diagram of a computer system in which event summarization can be implemented.

FIG. 2 illustrates an example diagram of a chronological summarization based on a natural language request.

FIG. 3 illustrates an example diagram of a topical summarization based on another natural language request.

FIG. 4 illustrates an example diagram of a process that identifies relevant images, then identifies more-important images, and creates a final arrangement of images.

FIG. 5 illustrates an example diagram of a computing device that allows a user to watch and control playback of an event summarization.

FIG. 6 illustrates an example diagram of an image processing system in which event summarization can be implemented.

FIG. 7 illustrates an example diagram of an event summarization system in which event summarization can be implemented.

FIG. 8 illustrates an example diagram of a natural language event processing system in which event summarization can be implemented.

FIG. 9 illustrates an example diagram of a multimodal embedding system in which event summarization can be implemented.

FIG. 10 illustrates an example method for summarizing events.

FIG. 11 illustrates an example method for processing one or more images from one or more image capture devices.

FIG. 12 illustrates an example method for identifying possible answers to a user query.

FIG. 13 illustrates an example method for identifying possible images associated with a user query.

FIG. 14 illustrates an example method for identifying and responding to a query associated with an event summarization request.

### DETAILED DESCRIPTION

### Overview

This document describes systems and techniques that summarize events responsive to a user or system request. Particular examples discussed herein interact with cameras operated by a user, such as a homeowner or an occupant of a home having at least one camera. However, the described systems and techniques are useful in a variety of different settings with cameras mounted in a variety of locations. For example, the described systems and techniques may be applied in residential settings, commercial environments, schools, worksites, healthcare locations, elder care locations, and the like. Other examples discussed herein may include cameras that are operated by other devices or systems instead of a user.

Various example configurations and methods are described throughout this document. This document now describes example methods and components of the described event summarization system.

### Example Devices

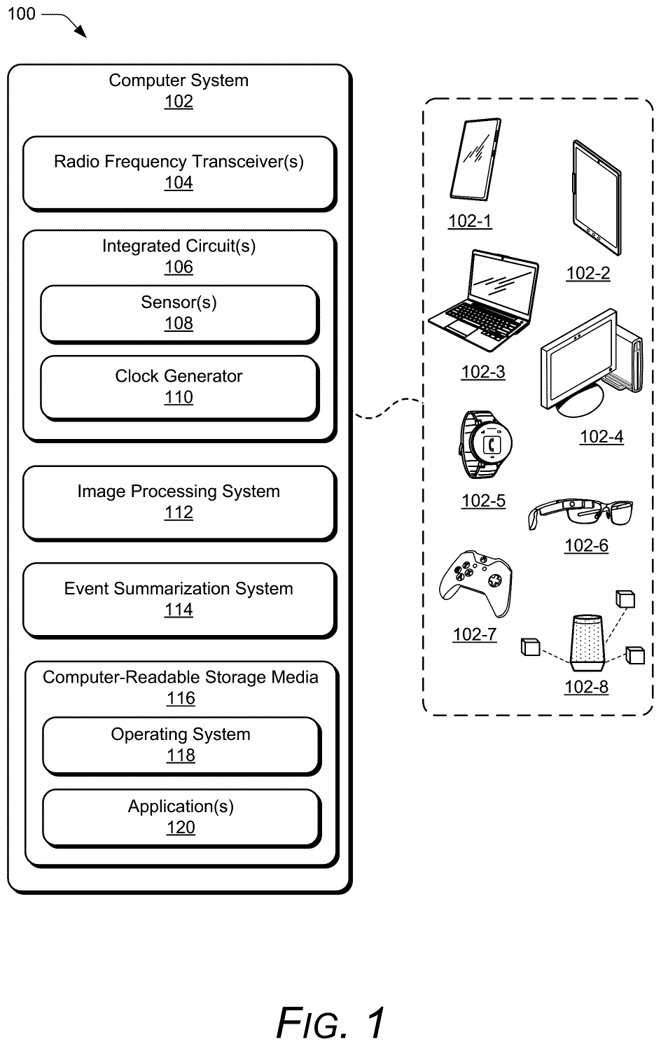

FIG. 1 illustrates an example diagram 100 of a computer system 102 in which event summarization can be implemented. The computer system 102 may include additional components and interfaces omitted from FIG. 1 for the sake of clarity.

The computer system 102 can be a variety of consumer electronic devices. As non-limiting examples, the computer system 102 can be a mobile phone 102-1, a tablet device 102-2, a laptop computer 102-3, a desktop computer 102-4, a computerized watch 102-5, a wearable computer 102-6, a video game controller 102-7, a voice-assistant system 102-8, and the like.

The computer system 102 includes one or more radio frequency (RF) transceiver(s) 104 for communicating over wireless networks. The computer system 102 can tune the RF transceiver(s) 104 and supporting circuitry (e.g., antennas, front-end modules, amplifiers) to one or more frequency bands defined by various communication standards.

The computer system 102 includes one or more integrated circuits 106. The integrated circuits 106 can include, as non-limiting examples, a central processing unit, a graphics processing unit, or a tensor processing unit. A central processing unit generally executes commands and processes needed for the computer system 102 and an operating system 118. A graphics processing unit performs operations to display graphics of the computer system 102 and can perform other specific computational tasks. A tensor processing unit generally performs symbolic match operations in neural-network machine-learning applications. The integrated circuits 106 can be single-core or multiple-core processors.

The computer system 102 also includes computer-readable storage media (CRM) 116. The CRM 116 is a suitable storage device (e.g., random-access memory (RAM), static RAM (SRAM), dynamic RAM (DRAM), non-volatile RAM (NVRAM), read-only memory (ROM), Flash memory) to store device data of the computer system 102. The device data can include the operating system 118, one or more applications 120 of the computer system 102, user data, and multimedia data. The operating system 118 generally manages hardware and software resources (such as the applications 120) of the computer system 102 and provides common services for the applications 120. The operating system 118 and the applications 120 are generally executable by the integrated circuits 106 (e.g., a central processing unit) to enable communications and user interaction with the computer system 102.

The integrated circuits 106 may include one or more sensors 108 and a clock generator 110. The integrated circuits 106 can include other components (not illustrated), including communication units (e.g., modems), input/output controllers, and system interfaces.

The one or more sensors 108 include sensors or other circuitry operably coupled to at least one integrated circuit 106. The sensors 108 monitor the process, voltage, and temperature of the integrated circuit 106 to assist in evaluating operating conditions of the integrated circuit 106. The sensors 108 can also monitor other aspects and states of the integrated circuit 106. The integrated circuit 106 can utilize outputs of the sensors 108 to monitor its chip state. Other modules can also use the sensor outputs to adjust the system voltage of the integrated circuit 106.

The clock generator 110 provides an input clock signal, which can oscillate between a high state and a low state, to synchronize operations of the integrated circuit 106. In other words, the input clock signal can pace sequential processes of the integrated circuit 106. The clock generator 110 can include a variety of devices, including a crystal oscillator or a voltage-controlled oscillator, to produce the input clock signal with a consistent number of pulses (e.g., clock cycles) with a particular duty cycle (e.g., the width of individual high states) at the desired frequency. As an example, the input clock signal can be a periodic square wave.

The computer system 102 also includes an image processing system 112 that can perform various image processing operations as discussed herein. For example, the image processing system 112 may analyze image data to identify objects, classify objects, identify activities, and store processed image data.

The computer system 102 further includes an event summarization system 114 that summarizes multiple events over a period of time, such as events captured by one or more cameras or other image capture devices. As discussed herein, the event summarization system 114 may receive user input, such as natural language input, or other input related to a desired summarization. In other aspects, the event summarization system 114 may receive input from one or more systems to create an event summarization. Based on the received input (e.g., event summarization request), the event summarization system 114 may identify multiple images and/or video clips that satisfy the received input. As used herein, an event summarization may include any number of events, activities, objects, and other information captured by an image capture device or other system.

For example, a user may provide a natural language request such as, “Show me a summary of the birds that visited my bird feeder yesterday.” In this example, the event summarization system 114 may identify various images and/or video clips showing birds at the bird feeder that were captured the previous day. The identified images may show one or more birds eating at the bird feeder, flying near the bird feeder, and the like. After identifying the images and/or video clips, the event summarization system 114 may edit the identified images and/or video clips to create a summary timelapse image sequence (e.g., timelapse video) or highlight image sequence (e.g., highlight video). In some aspects, the event summarization system 114 allows a user to easily request creation of a summary video using their natural language without needing to learn specific phrases. This document describes components and operation of the event summarization system 114 in greater detail herein.

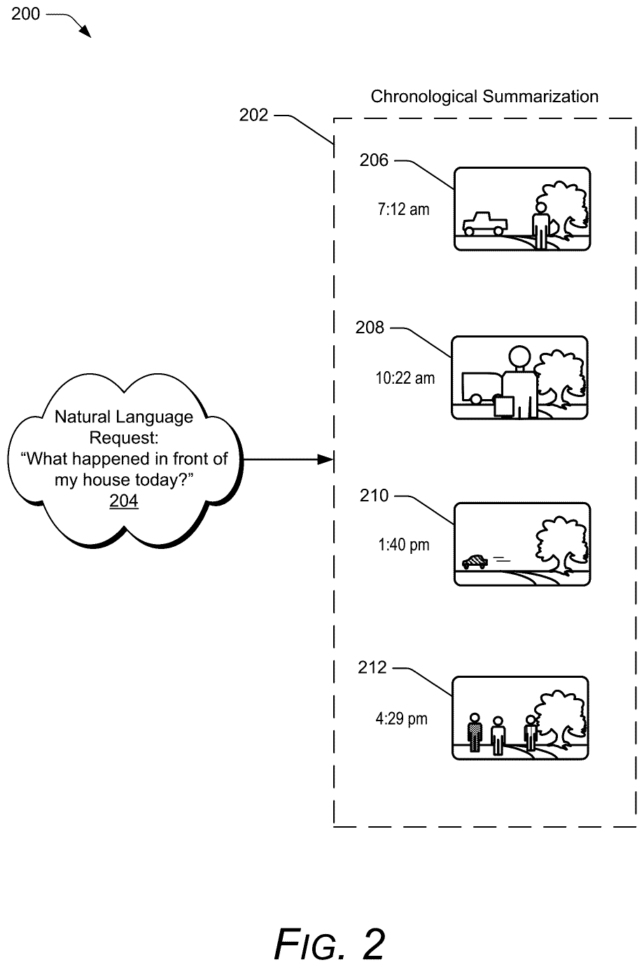

FIG. 2 illustrates an example diagram 200 of a chronological summarization 202 based on a natural language request. As shown in FIG. 2, the chronological summarization 202 of multiple events is generated in response to a natural language request 204. In this example, the natural language request 204 is received from a user or system that wants a summarization of “What happened in front of my house today?” In response to the natural language request 204, the systems and techniques create the chronological summarization 202 that includes images or video clips associated with multiple events or activities that happened in front of a particular house, e.g., on the day that the natural language request 204 is received.

In the example of FIG. 2, the chronological summarization 202 includes four images or video clips 206, 208, 210, and 212 that summarize events or activities that happened in front of the house. The image 206 shows a vehicle and a person in front of the house. The image 208 shows a truck and a person carrying a package in front of the house. The image 210 shows a car driving on a road in front of the house. The image 212 shows three people standing in front of the house. As shown in the chronological summarization 202, each image has an associated time that the image or video clip was captured. For example, the image 206 was captured at 7:12 am, the image 208 was captured at 10:22 am, the image 210 was captured at 1:40 pm, and the image 212 was captured at 4:29 pm. The chronological summarization 202 provides a user or system with a summary of what happened in front of the house by providing the images or video clips 206, 208, 210, 212. As discussed herein, the user may get more details or watch one or more images or video clips 206, 208, 210, 212 to get more information about the events that happened in front of the house.

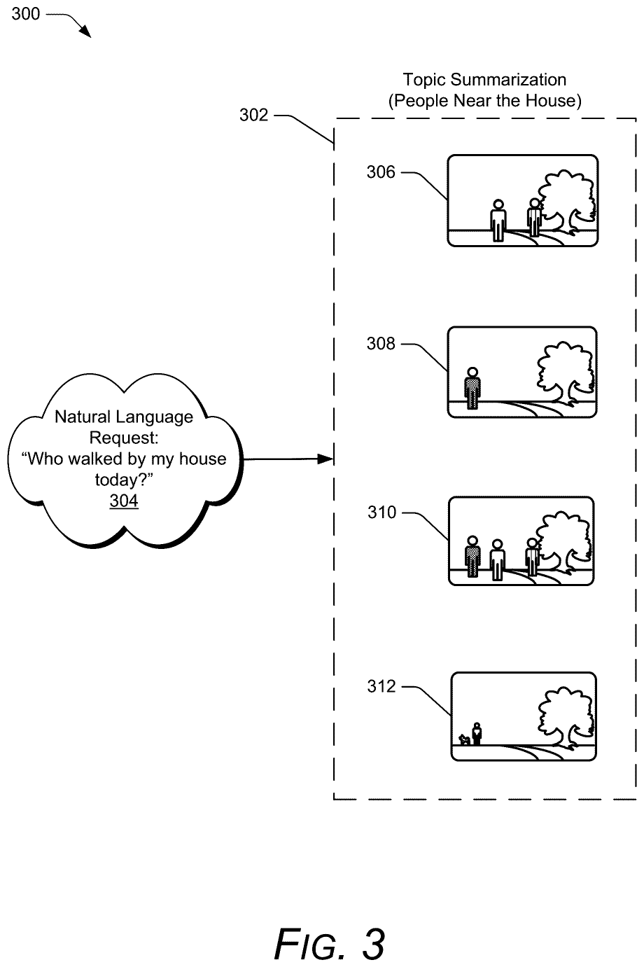

FIG. 3 illustrates an example diagram 300 of a topical summarization 302 based on another natural language request. The topical summarization 302 includes multiple events and is generated in response to a natural language request 304. In this example, the natural language request 304 is received from a user or system that wants a summarization of “Who walked by my house today?” In response to the natural language request 304, the systems and techniques create the topical summarization 302 that includes images or video clips associated with multiple events or activities associated with at least one person that occurred in front of a particular house on the day that the natural language request 304 is received.

In the example of FIG. 3, the topical summarization 302 includes four images or video clips 306, 308, 310, and 312 that summarize events or activities associated with people that walked by the house. The image 306 shows two people standing or walking in front of the house. The image 308 shows a single person in front of the house. The image 310 shows three people in front of the house. The image 312 shows a person and a dog walking in front of the house. In this example, the images or video clips 306, 308, 310, and 312 are based on a particular topic (e.g., people who walked by the house today). In the example of FIG. 3, the images or video clips 306, 308, 310, and 312 are not necessarily in chronological order. Instead, the images or video clips 306, 308, 310, and 312 are associated with the particular topic, regardless of when the image or video clip was captured. The topical summarization 302 provides a user or system with a summary of people who walked by the house by providing the images or video clips 306, 308, 310, 312. As discussed herein, the user may get additional details or watch one or more images or video clips 306, 308, 310, 312 to get more details about the people who walked by the house.

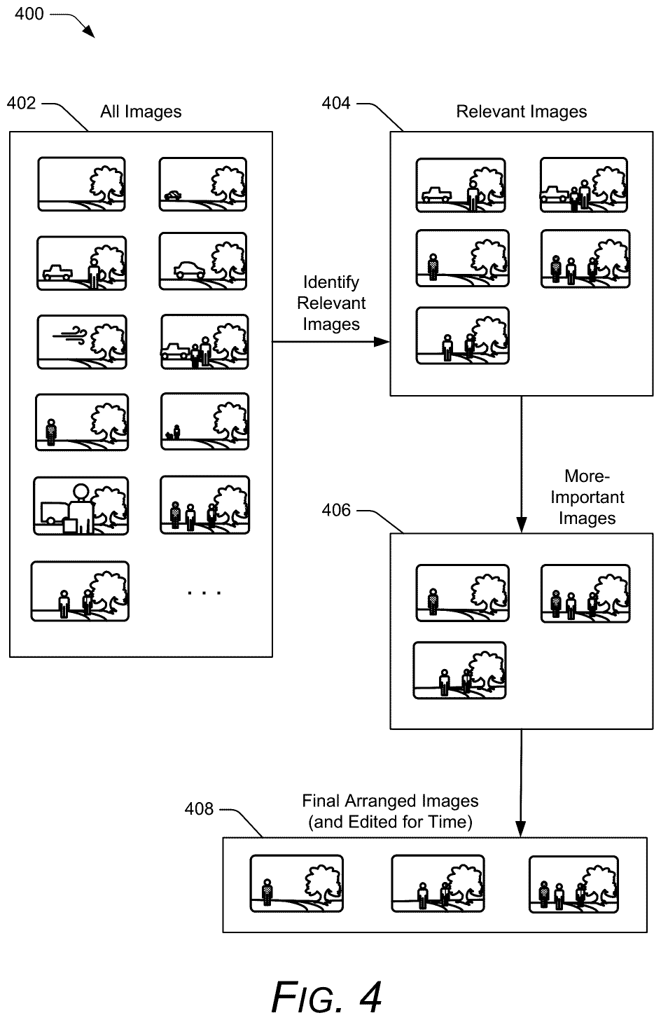

FIG. 4 illustrates an example diagram 400 of a process that identifies relevant images, then identifies more-important images, and creates a final arrangement of images. For example, all images 402 captured by one or more image capture devices are shown. Any number of images 402 may have been captured by any number of image capture devices. Based on a natural language request or other type of event summarization request, multiple relevant images 404 are selected from captured images 402. In this example, the relevant images 404 are selected based on a natural language request “Show me people in front of my house today.” The five relevant images 404 are selected from captured images 402 because they show people in front of the house.

In the example of FIG. 4, the five relevant images 404 are analyzed to identify three more-important images 406. In some aspects, the five relevant images 404 may be analyzed by a large language model or other artificial intelligence based system, as described herein. The analysis of the five relevant images 404 may be based on information about the natural language request, the content of the images, information about the user who generated the request, and the like. After the more-important images 406 are identified, the more-important images 406 are arranged in to a particular order 408, such as chronological order, topical order, theme order, and the like. As discussed herein, the arrangement order 408 of the more-important images 406 may be based on the natural language request, a user's feedback regarding previous event summarizations, the length of each of the more-important images 406, and the like. The images arranged in a particular order 408 are then communicated to a user or system for viewing. Additional details regarding identifying the relevant images 404, determining the more-important images 406, and arranging the images in a particular order 408 are discussed herein.

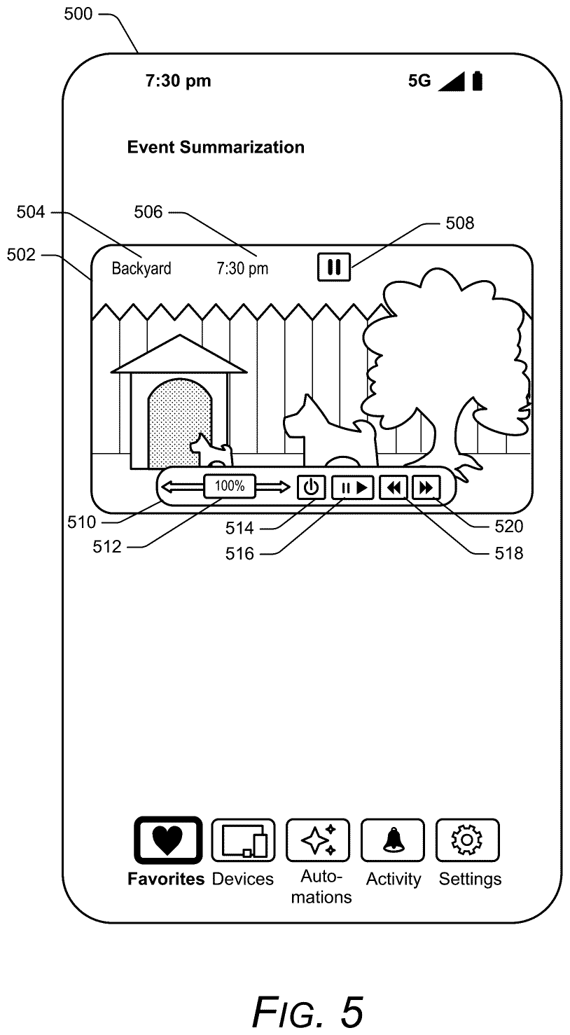

FIG. 5 illustrates an example diagram of a computing device 500 that allows a user to watch and control playback of an event summarization. The computing device 500 may be a mobile device (e.g., a smartphone), a tablet device, a laptop device, a desktop device, a wearable device, and the like. In the example of FIG. 5, the computing device 500 displays a particular image or video clip 502 on the computing device 500 display screen. In addition to the particular image or video clip 502, the computing device 500 display screen identifies a location 504 where the image was captured (e.g., backyard) and a time 506 that the image was captured (e.g., 7:30 pm). The computing device 500 display screen also displays a pause button 508 to pause playback of the video clip 502 or pause playback of an event summarization. In some aspects, The computing device 500 display screen also displays one or more user controls, such as a slider 510 that adjusts a size 512 of the image or video clip 502, a power button 514, a pause/play button 516, a rewind/back button 518, and a fast forward button 520.

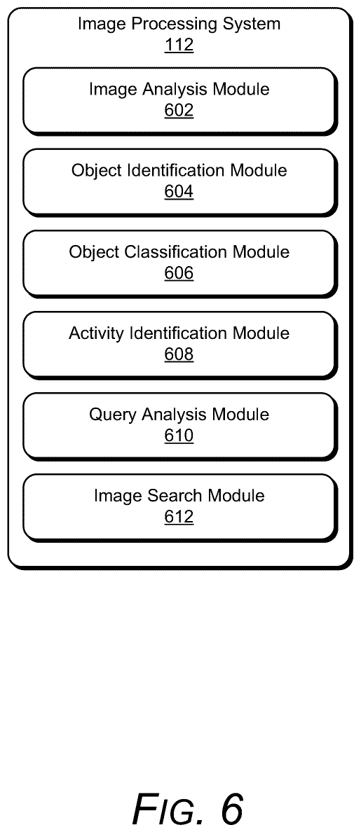

FIG. 6 illustrates an example diagram of the image processing system 112 in which event summarization can be implemented. In the example of FIG. 6, the image processing system 112 can perform various image processing operations as discussed herein. For example, the image processing system 112 may analyze image data (e.g., images and video captured by an image capture device) to identify objects, classify objects, identify activities, and store processed image data.

The image processing system 112 may receive or process images captured by any type of image capture device, such as a still camera, a video camera, and the like. The images may include a single image or a series of images (e.g., multiple image frames) captured during a particular period of time. In some aspects, the images may be captured by one or more cameras located near a house, yard, business, traffic intersection, parking lot, playground, sidewalk, and the like.

As shown in FIG. 6, the image processing system 112 includes an image analysis module 602, an object identification module 604, and an object classification module 606. The image analysis module 602 can perform a variety of image analysis operations such as analyzing the content of different types of images to determine image settings, image types, objects in an image, and other features. In some aspects, the image analysis module 602 performs different types of analysis based on the type of image being analyzed. For example, if the image includes one or more people, the image analysis module 602 may identify and analyze the people in a particular image or in a series of image frames. In other situations, if the image captures an outdoor scene, the image analysis module 602 may identify and analyze buildings, vehicles, people, trees, animals, roads, sidewalks, and the like contained in the image. The results of the analysis operations performed by the image analysis module 602 may be used by the object identification module 604, the object classification module 606, and other modules and systems discussed herein.

The object identification module 604 can identify various types of objects in one or more images. In some aspects, the object identification module 604 can identify any number of objects and any type of object contained in one or more images. For example, the object identification module 604 may identify people, animals, vehicles, toys, buildings, plants, trees, geological formations, lakes, rivers, airplanes, clouds, and the like. A particular image may include any number of objects and any number of different types of objects. For example, a particular image may include multiple people, one dog, a car, a driveway, several trees, and other related objects.

The object identification module 604 identifies and records objects in a particular image for future reference or future access. In some aspects, the object identification module 604 uses the results of the image analysis module 602. When recording objects in an image, the object identification module 604 may record data (by storing the data in any format) associated with each object, such as the object's location within the image or the object's location with respect to other objects in the image. In other examples, the object identification module 604 may identify and record one or more characteristics of each object, such as the object's type, color, size, orientation, shape, and the like. The results of the identification operations performed by the object identification module 604 may be used by the object classification module 606 and other modules and systems discussed herein.

The object classification module 606 can classify multiple types of objects in one or more images. In some aspects, the object classification module 606 uses the results of the image analysis module 602 and the object identification module 604 to classify each object in an image. For example, the object classification module 606 may use the object identification data recorded by the object identification module 604 to assist in classifying the object. The object classification module 606 may also perform additional analysis of the image to further assist in classifying the object.

The classification of an object may include a variety of factors, such as an object type, an object category, an object's characteristics, and the like. For example, a particular object may be identified as a person by the object identification module 604. The object classification module 606 may further classify the person as male, female, tall, short, young, old, dark hair, light hair, and the like. Other objects may have different classification factors based on the characteristics associated with the particular type of object. For example, vehicles may be classified based on size, color, brand, or vehicle type. The results of the object classification operations performed by the object classification module 606 may be used by one or more other modules and systems discussed herein.

As shown in FIG. 6, the image processing system 112 further includes an activity identification module 608, a query analysis module 610, and an image search module 612. The activity identification module 608 can perform a variety operations related to identifying one or more activities that are occurring in a particular image. For example, the activity identification module 608 may identify an activity associated with multiple objects in an image, such as movement of an object. In some aspects, the activity identification module 608 can identify that a ball is bouncing in a yard, a person is walking on a sidewalk, a car is moving along a road, a dog is sitting near a pool, and the like.

The type of identified activity may depend on the type of object (e.g., based on the object classification performed by the object classification module 606). In some situations, a particular object may have multiple identified activities. For example, a person may be running and jumping at the same time or alternating between running and jumping. Information related to the identified activity (or activities) associated with each object may be stored with each object for future reference. The results of the activity identification operations performed by the activity identification module 608 may be used by one or more other modules and systems discussed herein.

The query analysis module 610 can analyze queries, such as natural language queries from a user. In some aspects, the queries may request information related to objects or activities in one or more images. For example, a natural language query from a user may request a summary of events that occurred during a particular time period, such as, “Show images of my dog's activity this morning” or “What happened in my house during the last week.” In other aspects, a query may request a summary of events associated with a particular topic or theme, as discussed herein.

The query analysis module 610 can analyze the received query to determine the desired events, objects, or activities identified in the natural language query, then analyze captured images to identify the images desired by the user. In some implementations, the query analysis module 610 may use information generated by one or more of the image analysis module 602, the object identification module 604, the object classification module 606, and the activity identification module 608. Additional details regarding the operation of the query analysis module 610 are described herein. The results of the query analysis operations performed by the query analysis module 610 may be used by one or more other modules and systems discussed herein.

The image search module 612 can identify various types of objects or activities in one or more images. In some aspects, the image search module 612 can work in combination with the query analysis module 610 to identify images that satisfy a query from a user or system. For example, an image may be considered to satisfy details associated with a request to generate a summary of events or activities if an object and/or activity included in the details is identified in one or more images. Identifying an object and/or activity included in the details may correspond to detecting an event associated with the requested summary. In some implementations, the image search module 612 may use information generated by one or more of the image analysis module 602, the object identification module 604, the object classification module 606, the activity identification module 608, and the query analysis module 610. Additional details regarding the operation of the image search module 612 are described herein. The results of the image search operations performed by the image search module 612 may be used by one or more other modules and systems discussed herein.

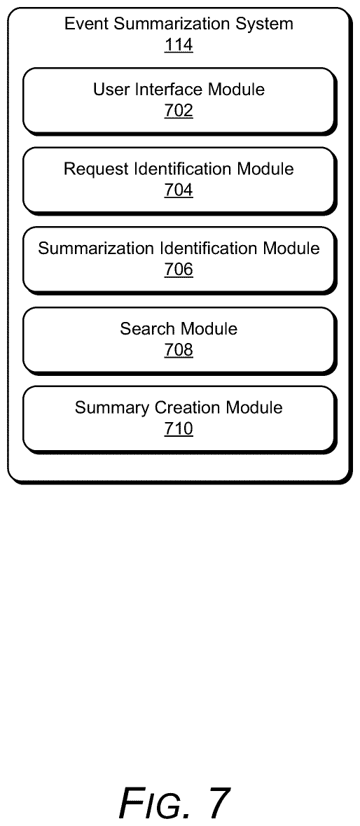

FIG. 7 illustrates an example diagram of the event summarization system 114 in which event summarization can be implemented. In the example of FIG. 7, the event summarization system 114 can perform various summarization processing operations as discussed herein. For example, the event summarization system 114 may receive user input in the form of natural language input requesting a summary of events based on a time period, a topic, a theme, and the like. As discussed herein, receiving user input via natural language may simplify the process of requesting an event summary because the user can simply speak their request without needing to learn specific phrases defined by the event summarization system 114. For example, an input may request, “Show me what my dog did in the back yard yesterday.” Based on the received user input, the event summarization system 114 may identify one or more images associated with the requested summary of events. The identified images may include images associated with the requested summary, such as events associated with the request. In the example mentioned above, the identified images may include still images or video clips of the user's dog in the back yard during the previous day.

As discussed herein, the event summarization system 114 may create a summary of the events by analyzing and summarizing the one or more images. The summary of the events may be created in the form of a video summary of events including a series of images, a series of video clips, a combination of images and video clips, and the like. In some aspects, the video summary of events may include a portion of the one or more identified images while excluding some of the identified images. Some images may be excluded to include the more-important images, remove substantially similar images, create a video summary of events with a particular duration, and the like. The video summary may be presented or communicated to the user in response to their request for a summary of events.

As shown in FIG. 7, the event summarization system 114 includes a user interface module 702 and a request identification module 704. The user interface module 702 allows one or more users to interact with the event summarization system 114. The user interface module 702 may allow a user to interact via natural language, a keyboard, a touch screen, or any other mechanism. In some aspects, a user may interact with the user interface module 702 using a mobile computing device, a desktop computing device, a laptop computing device, or any other type of device. In some examples, a particular device may be associated with the event summarization system 114 that allows the user to communicate via the user interface module 702. In other examples, the user may interact with the user interface module 702 using a device that is separate from the event summarization system 114.

The user interface module 702 allows a user to provide various event summarization requests, commands, settings, and the like. In some situations, the user interface module 702 may provide responses to the user to confirm receipt of the user's request, command, setting, and the like. The user interface module 702 may also communicate questions to the user regarding creating a particular event summarization, revising an existing event summarization, and the like, as discussed herein. These questions may be provided to the user via audio signals, video signals, display on a screen, communication of messages to the user's mobile computing device, email messages, and any other communication mechanism. Additional details regarding the operation of the user interface module 702 are described herein. The results of the user interface operations performed by the user interface module 702 may be used by one or more other modules and systems discussed herein.

The request identification module 704 identifies a user's request contained in the user's input via natural language, a keyboard, a touch screen, or any other mechanism. In some aspects, the user's request is associated with the user's desire to watch a summary of particular events. When the user's input is via natural language, the user's request may be determined based on text or phrases in the user's input by the request identification module 704. For example, if the user's natural language input is, “What happened in the back yard today?” the request identification module 704 may identify the individual words in the natural language input. The request identification module 704 then identifies the user's intent and one or more details associated with the request. For example, a natural language request, “What did my cat do this morning?” may cause request identification module 704 to determine that the user wants to watch a summary of their cat's activities (e.g., events) that happened during the morning hours. Additional details regarding the operation of the request identification module 704 are described herein. The results of the request identification operations performed by the request identification module 704 may be used by one or more other modules and systems discussed herein.

As shown in FIG. 7, the event summarization system 114 further includes a summarization identification module 706, a search module 708, and a summary creation module 710. The summarization identification module 706 may identify the types of events or activities to include in a particular event summarization. In the above example, the summarization identification module 706 may determine that events related to the user's cat should be included in the event summarization. Additionally, the summarization identification module 706 may determine that the event summarization should include cat-related events that occurred between 6:00 am and 12:00 pm that day. Additional details regarding the operation of the summarization identification module 706 are described herein. The results of the summarization identification operations performed by the summarization identification module 706 may be used by one or more other modules and systems discussed herein.

The search module 708 can search through any number of images from any number of image capture devices to identify objects and activities that may be related to one or more events associated with a summarization. For example, if an event summarization is related to the user request, “What did my cat do this morning?” the search module 708 may search for images captured during the morning that show the user's cat. In some aspects, the search module 708 may issue a search command or search query to the image processing system 112 to identify specific images that may be relevant to an event summarization associated with the above user request. Additional details regarding the operation of the search module 708 are described herein. The results of the search operations performed by the search module 708 may be used by one or more other modules and systems discussed herein.

The summary creation module 710 can create an event summary based on a user's request. In some aspects, the summary creation module 710 may use information from the image processing system 112, request identification module 704, summarization identification module 706, search module 708 and other systems and modules discussed herein to create an event summary. For example, if the user requests, “What did my cat do this morning?”, the summary creation module 710 may create a video summary showing various images of the cat involved in activities or events that morning. The summary creation module 710 may also determine the more-important images to include in the summary, such as the most interesting things the cat did in the morning. Additionally, the summary creation module 710 may remove duplicate images or images that are substantially similar. For example, if the cat was sleeping in the same location in multiple images, one or more of the multiple images may be deleted to avoid repetitive images. If the event summarization has a time limit (or time target), some of the less interesting images may be deleted from the summary to meet the time limit. Additional details regarding the operation of the summary creation module 710 are described herein. The results of the event summary creation operations performed by the summary creation module 710 may be used by one or more other modules and systems discussed herein.

In some examples, a user or system may request an event summarization associated with a home. Requests related to a home may include, for example, “Show me the birds in my back yard today,” “What games did my kids play today”, or “What happened in my house during the last seven days?”

In other examples, a user or system may request an event summarization associated with a business office. For example, the request may include, “Who was in the office after 8:00 pm last night”, “What happened in the office this morning,” or “Show me the cleaning crew activities last night.”

Other examples may include event summarizations associated with a factory or warehouse. Such example requests may include, “Show me when the assembly line went down in the last month” or “Give me a summary of the products produced and shipped from the warehouse today.”

Some requests may be associated with a school, such as “Show me a five minute summary of last week's school dance,” “When were students in the hallway after the bell rang,” or “Show me the students who helped clean up the cafeteria today.”

In some examples, a user or system may request an event summarization associated with a party, such as a birthday party. Requests related to a party may include, for example, “Show me a three minute summary of Katie's birthday party,” “What gifts did Robert get at his retirement party,” “Who attended Amy's recent party,” or “What games were played at the last high school graduation party?”

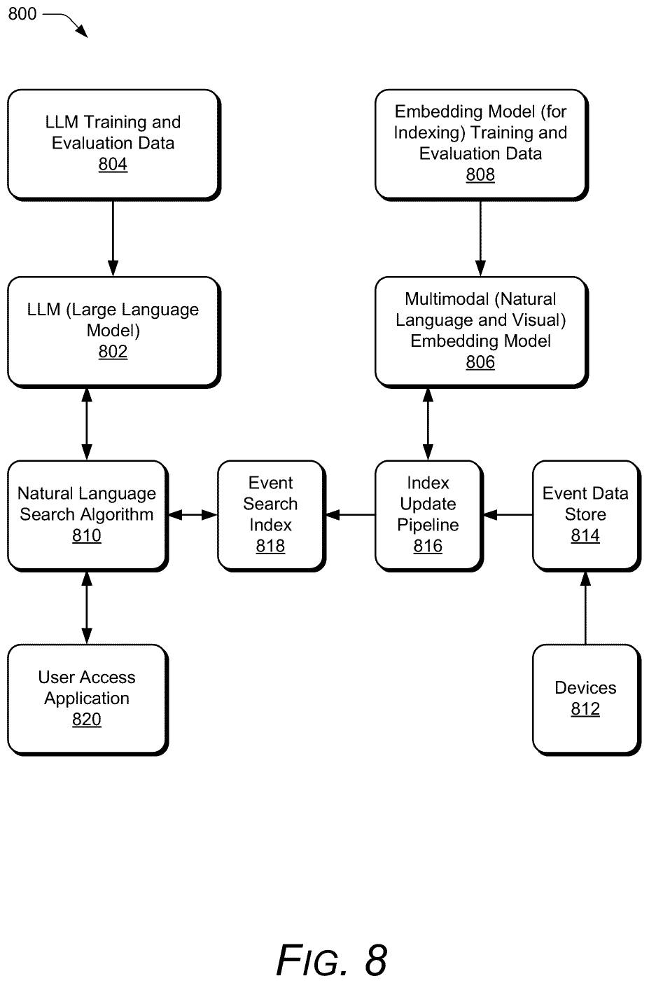

FIG. 8 illustrates an example diagram of a natural language event processing system 800 in which event summarization can be implemented. The natural language event processing system 800 includes an LLM (Large Language Model) 802. The LLM 802 is a model used to analyze large amounts of data and learn various patterns between the data elements, such as patterns or connections between words, phrases, images, and the like. In some aspects, the LLM 802 may, in response to one or more prompts or queries, summarize events and locate any number of relevant video images, video clips, or still images associated with the summarized events. One or more of these video images, video clips, or still images may be used to create a timelapse video or highlight video summarizing multiple events.

The LLM 802 may be trained using LLM training and evaluation data 804. The LLM training and evaluation data 804 may include real world data, simulated data, synthetic data, and the like. In some aspects, the LLM 802 may begin with a foundation model already trained on a variety of information. The foundation model is further trained (e.g., fine-tuned for the particular application) by collecting example data based on real inputs and outputs, such as historical data. Additionally, the evaluation, summarization, and other functions performed by LLM 802 may be continually updated (e.g., improved) based on feedback from users, administrators, other systems, and the like. For example, if a user provides negative feedback (e.g., not an acceptable event summary), an administrator or other person may re-create the user query and identify a how to create a better response or summary. The LLM training and evaluation data 804 and/or the LLM 802 is then updated based on the identified correct response or summary.

The natural language event processing system 800 also includes a multimodal embedding model 806. In some aspects, the multiple modes of the multimodal embedding model 806 include natural language embedding and image embedding, as discussed herein. The multimodal embedding model 806 may be trained using embedding model training and evaluation data 808. The embedding model training and evaluation data 808 may include real world data, simulated data, synthetic data, and the like. In some examples, the multimodal embedding model 806 may use the embedding model training and evaluation data 808 for indexing various data used by the natural language event processing system 800. In some examples, the embedding model training and evaluation data 808 may process captured images to generate an embedding space (also referred to as a vector space) based on the captured images. As discussed herein, the indexing process associates text with one or more images.

The natural language event processing system 800 further includes a natural language search algorithm 810. In some aspects, the natural language search algorithm 810 communicates with the LLM 802 to summarize or determine meanings of natural language input provided by a user or another system. For example, the natural language search algorithm 810 may communicate a natural language input (e.g., a query or prompt received from a user) to the LLM 802, which determines the user's question, intent, desire, and the like contained in the natural language input.

As discussed herein, the query or prompt received from a user may be associated with a user's desire to receive an event summarization. For example, the query or prompt may include, “What happened in my house today.” In some aspects, the natural language search algorithm 810 may receive the natural language input from one or more user access applications 820. In particular implementations, the one or more user access applications 820 are executing on a device operated by the user, such as a smartphone, a computer, or other computing device capable of communicating with the natural language search algorithm 810. In other implementations, the user may submit a query or prompt to a separate device (e.g., a network-enabled device in a smart home or smart office) that is coupled to communicate with the natural language search algorithm 810.

The determined question, intent, desire, or the like is communicated to the natural language search algorithm 810 or any device, such as a computing device, that's executing the natural language search algorithm 810. In some aspects, the natural language search algorithm 810 may receive information (e.g., natural language requests) from one or more users via one or more user access applications 820.

In some examples, the natural language search algorithm 810 transforms a received query into a structured search query that's provided to the LLM 802. The structured search query is processed by the LLM 802, which returns the results of the structured search query to the natural language search algorithm 810. The results from the LLM 802 are communicated from the natural language search algorithm 810 to an event search index 818. In some aspects, the event search index 818 receives the results from the natural language search algorithm 810 and identifies any images associated with the results of the structured search query.

As discussed herein, the LLM 802 is used to process custom structured queries to search for relevant images (e.g., images relevant to a requested summarization). For example, the LLM 802 may determine an intent of the user or system generating the query and may generate structured queries specifically for searching and identifying relevant images.

The natural language event processing system 800 illustrated in FIG. 8 may also include one or more devices 812. The example devices 812 include image capture devices, microphones, network-enabled devices in a smart home or smart office, and the like. The data captured by the devices 812 is communicated to an event data store 814 that may store data related to events captured by the devices 812 or other devices. The data related to events captured by the devices 812 may be analyzed as discussed herein to generate event summarizations.

The natural language event processing system 800 may also include an index update pipeline 816, which receives data from the event data store 814. The index update pipeline 816 performs various operations related to indexing data used by the natural language event processing system 800. The index update pipeline 816 communicates with the multimodal embedding model 806 and communicates information to the event search index 818. In some aspects, the index update pipeline 816 updates the multimodal embedding model 806 based on received data from the one or more devices 812. Data related to the event search index 818 is also provided to the natural language search algorithm 810. Additionally, the natural language search algorithm 810 provides information to the event search index 818, as shown in FIG. 8.

As discussed herein, a text structured search is used by the LLM 802 and the natural language search algorithm 810 to generate one or more text embeddings. The text embeddings are searched using the event search index 818 to compare the text to images in a manner that identifies images that are relevant to the text being searched.

In some aspects, image data may be pre-processed prior to receiving a query from the user access application 820. This pre-processing enhances performance of the systems and techniques because the received text queries can be processed faster since the image data has already been processed. For example, a received text query may be converted to a text embedding and the event search index 818 may search for pre-processed image data that matches the text embedding associated with the received text query.

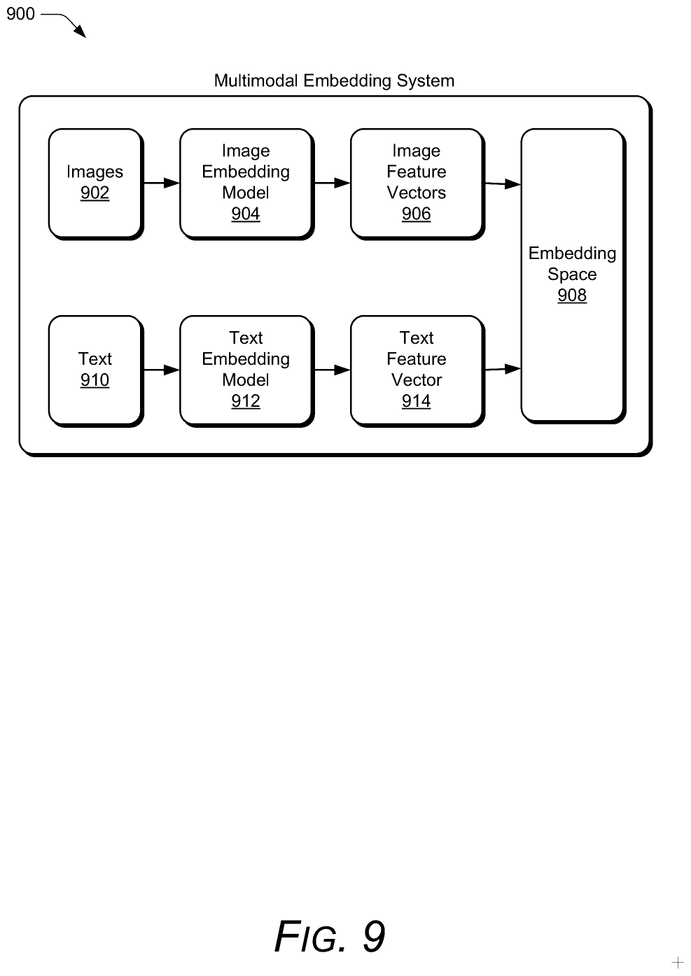

FIG. 9 illustrates an example diagram of a multimodal embedding system 900 in which event summarization can be implemented. The multimodal aspect of the multimodal embedding system 900 refers to the system's ability to handle image embedding and text embedding while also identifying text segments that are associated with one or more images. The multimodal embedding system 900 includes one or more images 902 that are captured, for example, by one or more image capture devices such as cameras. The multiple images 902 are provided to an image embedding model 904, which generates multiple image feature vectors 906 based on the received images 902. In some implementations, each image feature vector 906 may represent one image 902. In some aspects, the image feature vectors 906 may be large floating point numbers that identify various aspects of a particular image 902. As shown in FIG. 9, the image feature vectors 906 are mapped to an embedding space 908. In some aspects, the image feature vectors 906 are mapped to specific points in the embedding space 908 based on the floating point numbers associated with each image feature vector 906.

The multimodal embedding system 900 also includes one or more text segments 910 that may be received from one or more users. For example, a text segment 910 may be a portion of text associated with a user request of the type discussed herein. The user request may include the user's natural language request to create an event summarization, revise an event summarization, and the like. The text segment 910 is provided to a text embedding model 912, which generates a text feature vector 914 based on the text segment 910. In some aspects, each text feature vector 914 may be a large floating point number that identifies various aspects of the text segment 910. In some implementations, each text feature vector 914 may represent one text segment 910. The text feature vector 914 is mapped to the embedding space 908, which is the same embedding space 908 that image feature vectors are mapped to. In some aspects, the text feature vector 914 is mapped to specific points in the embedding space 908 based on the floating point numbers associated with each text feature vector 914. In some implementations, images 902 may be received and processed into image feature vectors 906 prior to receiving the text segment 910.

Thus, both the image feature vectors 906 and the text feature vectors 914 are mapped to the same embedding space 908 although they may be mapped to different points in the embedding space 908 based on the floating point numbers associated with their respective feature vectors 906, 914. Since both feature vectors are mapped to the same embedding space 908, the multimodal embedding system 900 can identify relationships between images 902 and text segment 910. For example, the systems and techniques described herein may identify one or more images 902 associated with a particular text segment 910. In some aspects, the multimodal embedding system 900 is used for retrieving data associated with the images 902 and the text 910.

For example, the multimodal embedding system 900 may identify a user's natural language statement, “What has my dog done today,” to create an event summarization associated with the dog's activities. Based on information in the embedding space 908, the multimodal embedding system 900 may identify one or more images 902 that include the user's dog (e.g., based on images captured by an image capture device that detects activities in the user's home). If an image 902 is identified that includes the user's dog, the image 902 may be used in the event summarization if it is within the requested time period (e.g., today).

In some aspects, the multimodal embedding system 900 includes two parallel pipelines, an image pipeline and a text pipeline. The image pipeline includes the path in the multimodal embedding system 900 that includes the images 902, the image embedding model 904, and the image feature vectors 906. The text pipeline includes the path in the multimodal embedding system 900 that includes the text segments 910, the text embedding model 912, and the text feature vector 914. As discussed above, the image pipeline may be pre-processed prior to receiving any text segments 910. For example, as soon as one or more images 902 are received, they are processed to create image feature vectors 906 that are included in embedding space 908. When the text segment 910 is received in the text pipeline, it can be processed immediately. The text feature vector 914 is then compared to image feature vectors 906 in the embedding space 908 to find any relevant images 902 that match the text segment 910.

Additionally, when new images 902 are received, they may be processed using the image pipeline discussed above. In this situation, the new image feature vectors 906 associated with the new images 902 are stored in the embedding space 908 and ready for use with future event summarization requests. In some examples, the event search index 818 (FIG. 8) performs the matching between the image feature vectors 906 and the text feature vectors 914 in embedding space 908.

### Example Methods

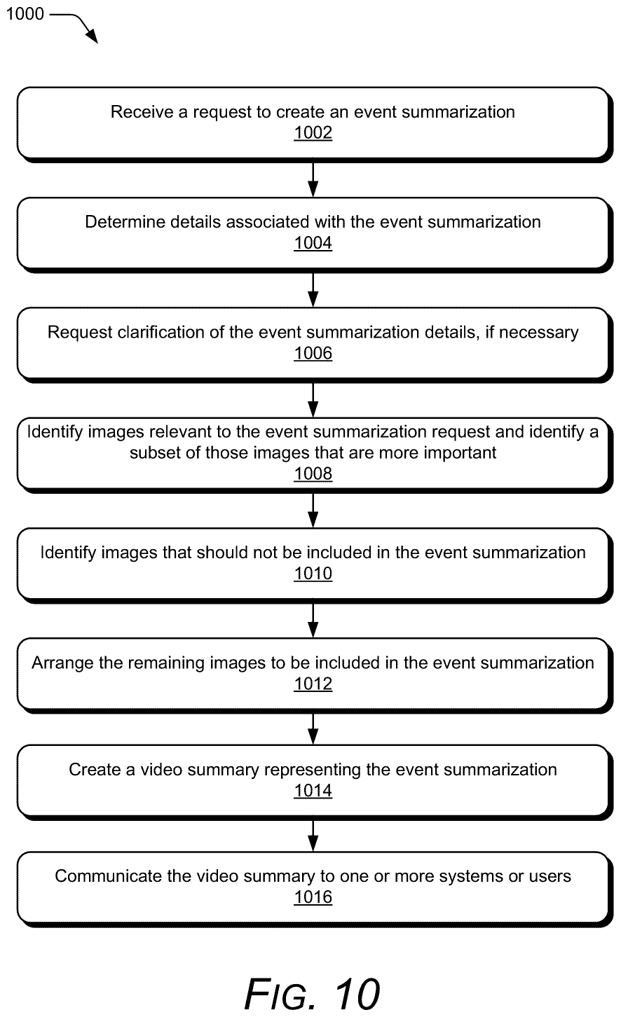

FIG. 10 illustrates an example method 1000 for summarizing events. In some implementations, at least a portion of the method 1000 may be performed by one or more of the modules contained in the event summarization system 114. As discussed herein, the method 1000 may be implemented to summarize one or more events over a period of time based on a received request from a system or user.

At 1002, the method 1000 receives a request to create an event summarization. As discussed herein, the event summarization request may be received from a system or a user. Event summarization requests received from a user may be provided using the user's natural language to describe the requested summarization. Example event summarization requests from a user may include, “What happened in my front yard today,” “Who walked past my house on the sidewalk this morning,” or “Show me the birds that visited the bird feeder in the last 24 hours.” In some aspects, receiving the request to create an event summarization may be performed by the user interface module 702.

At 1004, the method 1000 determines details associated with the requested event summarization. As discussed herein, the summarization details may include objects to include in the summarization (e.g., dog, kids, birds, or cars), activities to include in the summarization (e.g., dog playing, people walking, or birds at bird feeder), a time period associated with the summarization (e.g., this morning, yesterday, the last 7 days, or during the past hour), a time limit for the summarization (e.g., a 3 minute summary, a 60 second summary, or a 10 minute summary), and the like. In particular implementations, the summarization details may be determined by analyzing a user's natural language request, analyzing a system's request, and the like. In some aspects, the determination of details associated with the requested event summarization may be performed by the request identification module 704 and/or the summarization identification module 706.

At 1006, the method 1000 may request clarification of the event summarization details if necessary. For example, if the received event summarization request does not include all details necessary to create the event summarization, the method may ask one or more questions to clarify all details needed to create the event summarization. If the event summarization request does not include a time period associated with the summary, the systems and techniques may ask the user or system to provide the additional details. In some embodiments, if the event summarization request was received from a user, the systems and techniques may ask the user to provide the additional details via an audible message, visual message, text message, and the like. If the event summarization request was received from a system, the systems and techniques may ask the system that sent the request to provide the additional details via any type of message or communication approach. In some aspects, the determination of details associated with the requested event summarization may be performed by the request identification module 704 and/or the summarization identification module 706.

At 1008, the method 1000 identifies images relevant to the event summarization request and identifies a subset of those images that are more important. In some situations, the subset of images may include all of the identified images relevant to the event summarization request. In some aspects, relevant images may be identified by searching some or all available images captured by one or more image capture devices. For example, if the event summarization request includes, “Show me birds at my bird feeder yesterday,” the method may identify images that were captured “yesterday” of birds at the bird feeder. As discussed herein, the images may be still images, video clips, and the like. In this example, the identified images may include a significant number of relevant images if many birds visited the bird feeder yesterday. The systems and techniques will ignore images that don't satisfy the event summarization request (e.g., images without birds, images of birds that are not at the bird feeder, or images that were not captured yesterday). In some aspects, the image identification may be performed by the search module 708 and/or various modules of image processing system 112. Operations of 1008 and 1010 are set forth as separate operations and, in the case of 1008, includes multiple operations. Each of these operations, however, may be combined or divided, e.g., into one or three operations. Thus, in aspects, the techniques can determine images to include in the event summarization from analyzing images relevant to the event summarization request, such by using a machine-learned model.

At 1010, the method 1000 identifies one or more images identified at 1008 that should not be included in the event summarization. For example, images that are duplicates (or substantially similar to other images) may not be included in the event summarization. Instead, the method may prefer to include multiple different images in the event summarization to make the summarization more interesting rather than repeating the same (or substantially similar) images. In some examples, images that are low quality (e.g., blurry, objects are too far away, or the relevant part of the image is blocked by another object) may not be included in the event summarization. Low-quality images may degrade the overall quality of the event summarization and reduce the value to the viewer of the summarization. In particular implementations, if there are too many images for the time limit associated with the summarization, some images may need to be removed to keep the summarization within the time limit. In this situation, the systems and techniques may remove images that are not interesting or less relevant to the overall summarization. The resulting set of selected images are used to create a video summary, as discussed herein. In some aspects, the identification of images that should not be included in the event summarization may be performed by the summary creation module 710.

At 1012, the method 1000 arranges the remaining images to be included in the event summarization. For example, the selected images may be arranged in a chronological order, arranged based on a theme, arranged based on a topic, arranged based on potential viewer interest, and the like. Arranging the images in chronological order may be referred to as a timelapse, which shows the viewer what happened during the time period in the specific temporal order. Arranging the images based on a theme or topic may group together images with a common theme or topic (e.g., yellow birds, cardinals, large birds, or small birds). In some aspects, the arranging of the images in the event summarization may be performed by the summary creation module 710.

At 1014, the method 1000 creates a video summary representing the event summarization. The video summary may include the images identified at 1010 and arranged at 1012. In some implementations, the amount of time an image is displayed in the video summary may vary depending on the value or importance of the image. Images that are perceived to be of higher value or importance may be displayed in the video summary for a longer period of time than other videos with a lower value or importance. The video summary is created to be no longer than the time limit associated with the summarization. In some aspects, the creation of the video summary may be performed by the summary creation module 710.

At 1016, the method 1000 communicates the video summary to one or more systems or users. For example, the video summary may be communicated to a user requesting the event summarization, a system requesting the event summarization, or any other system or user. The video summary can be communicated using any communication channel, communication technique, communication system, communication protocol and the like. In some aspects, the recipient of the video summary may be included in the details associated with the event summarization.

In some embodiments, the video summary is created to satisfy a particular time limit for the summarization. This may be accomplished by determining a time limit for each image or video clip. The time limit for each image can be determined based on the number of images in the summarization and the time limit for the entire summarization. For example, if the time limit for the summarization is three minutes and there are 45 images or video clips to include in the summarization, a time limit for each image may be set to four seconds (e.g., three minutes divided by 45 images). If any of the images or video clips require more than four seconds, other images or video clips may be shortened (e.g., less than four seconds) to stay within the time limit for the summarization.

In other situations, the systems and techniques may select the number of images or video clips to include in the summarization based on the time limit for the summarization and the approximate time to display each image or video clip in the summarization. For example, if the time limit for the summarization is two minutes and each image will be displayed for approximately three seconds, the summarization can include approximately 40 images. In this situation, the systems and techniques may select the best 40 images to display in the summarization. In some implementations, the best 40 images may be selected using LLM 802 and other modules and systems discussed herein.

When creating an event summarization, the systems and techniques may adjust the time that each image or video clip is displayed in the event summarization. For example, if a particular image is of high importance, it may be displayed in the event summarization longer than other, less important, images.

In some examples, the systems and techniques may suggest particular time limits for various types of event summarizations and suggest time limits for images or video clips included in the summarization. These suggestions may be based on user feedback, user viewing behavior (e.g., how long the user watched each event summarization), user engagement rate, and the like.

In some aspects, the systems and techniques may access images from multiple image capture devices, such as a camera facing a home's front yard and another camera facing the home's back yard. When creating an event summarization, the images from the multiple cameras may be combined in a common event summarization. In other situations, a particular event summarization may use images from one of the cameras (e.g., when the event summarization request specifically includes activities in the back yard).

In some situations, a person or pet may be moving from the view of one camera to another. For example, a dog may be playing in the back yard (visible by a back yard camera), then go to the front yard (visible by a front yard camera). The event summarization may track the dog's location and show the dog “traveling” from the back yard to the front yard by including chronological images from the back yard camera and the front yard camera.

A single event summarization may include multiple themes or topics. For example, an event summarization related to a request, “What happened in my house today” may arrange the images and video clips into multiple themes or topics. A first part of the event summarization may show images related to activities associated with the kids' activities in the house. A second part of the event summarization may show activities of the dog. A third part of the event summarization may show activities happening near the front door of the house.

As discussed herein, the event summarization systems and techniques use images or video clips captured by cameras to create an image summarization. In some situations, additional images not captured by a camera may be added to an event summarization, such as transition images between images or video clips. The transition images may be generated by artificial intelligence based on other images in the event summarization. Additionally, text or graphics may be added to the event summarization to provide context and other information, such as a date, a time period, a location, people involved, animals involved, who requested the summarization, and the like.

In some implementations the captured images may include a series of still images. These still images can be used to create animations that resemble video clips and add more activity to the video summary.

When creating the video summary, the described systems and techniques may highlight or emphasize interesting portions of the video summary. For example, the systems and techniques may magnify a portion of an image, such as the portion with a dog, add text or other information identifying a portion of an image, and the like.

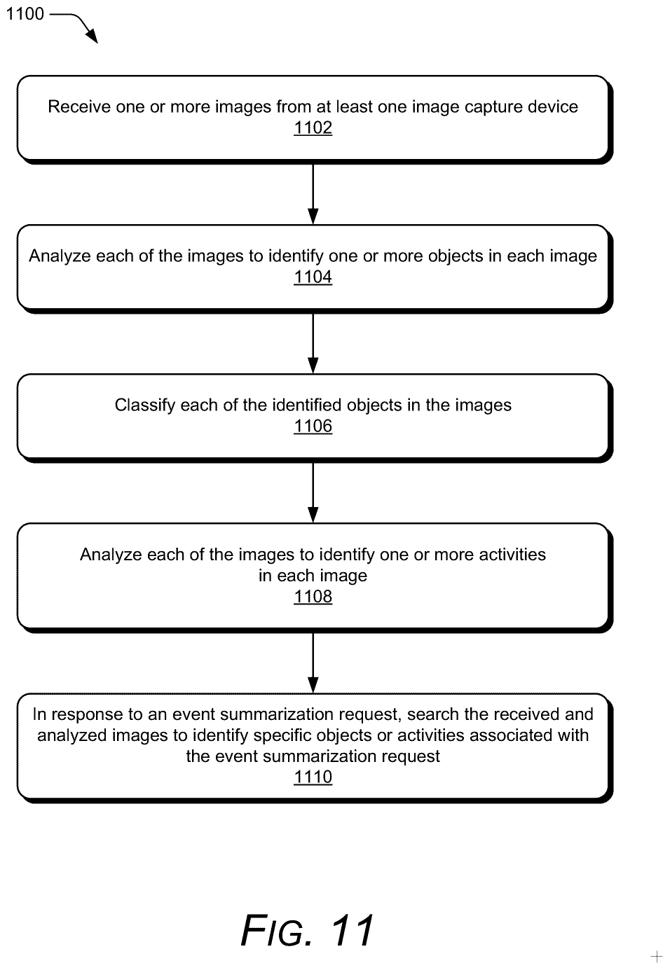

FIG. 11 illustrates an example method 1100 for processing one or more images from one or more image capture devices. In some implementations, the method 1100 may be performed by one or more of the modules contained in the image processing system 112. As discussed herein, the method 1100 may be implemented to assist in creating event summarizations using, for example, natural language input from one or more users or a request from one or more systems.

At 1102, the method 1100 receives one or more images from at least one image capture device. For example, images may be captured by one or more cameras associated with a user's home, a business, a roadway, or any other structure or location. The one or more cameras may be located inside a home/business, outside a home/business, or any other location. In some implementations, the image capture device may be activated to record video segments (or still photos) in response to detecting movement. For example, the image capture device may be activated when a vehicle drives through the device's field of view, a person walks near the device, an animal moves near the device, an object moves near the device, and the like. In other situations, the image capture device may capture images at periodic intervals, such as every few seconds, once per minute, and the like regardless of whether any movement or a particular object was detected.

At 1104, the method 1100 analyzes each of the images to identify one or more objects in each image. This analysis may include analyzing multiple still images or analyzing a series of image frames in a video recording. Identified objects may include people, animals, vehicles, toys, buildings, plants, trees, geological formations, lakes, rivers, airplanes, clouds, and the like. As discussed herein, the identified objects may be useful in determining whether a particular image should be included in an event summarization. In some aspects, the analysis of the images may be performed by the image analysis module 602 and the objects may be identified by the object identification module 604 discussed herein with respect to FIG. 6.

At 1106, the method 1100 classifies each of the identified objects in the images. This classification may include multiple factors, such as an object type, an object category, an object's characteristics, and the like. For example, if a particular object has been identified as a person at 1104, the person may be further classified as male, female, tall, short, young, old, dark hair, light hair, and the like. Different objects may have different classification factors based on the characteristics associated with the particular type of object. As discussed herein, the object classification may be useful in determining whether a particular image should be included in an event summarization. In some aspects, the object classification may be performed by the object classification module 606.

At 1108, the method 1100 analyzes each of the images to identify one or more activities in each image. This analysis may include analyzing multiple still images or analyzing a series of image frames in a video recording. Identified activities may include a ball bouncing in a yard, a person walking on a sidewalk, a car driving along a road, a dog sitting near a pool, and the like. As discussed herein, the identified activities are useful in determining whether a particular image should be included in an event summarization. In some aspects, the activities may be identified by the activity identification module 608.

At 1110, in response to an event summarization request, the method 1100 searches the received and analyzed images to identify specific objects or activities associated with the event summarization request. For example, the event summarization request may be a natural language request from a user to create an event summarization, as discussed herein. In some aspects, results of the search may be useful in determining whether a particular image should be included in an event summarization. In some aspects, the search may be performed by the query analysis module 610 and/or the image search module 612.

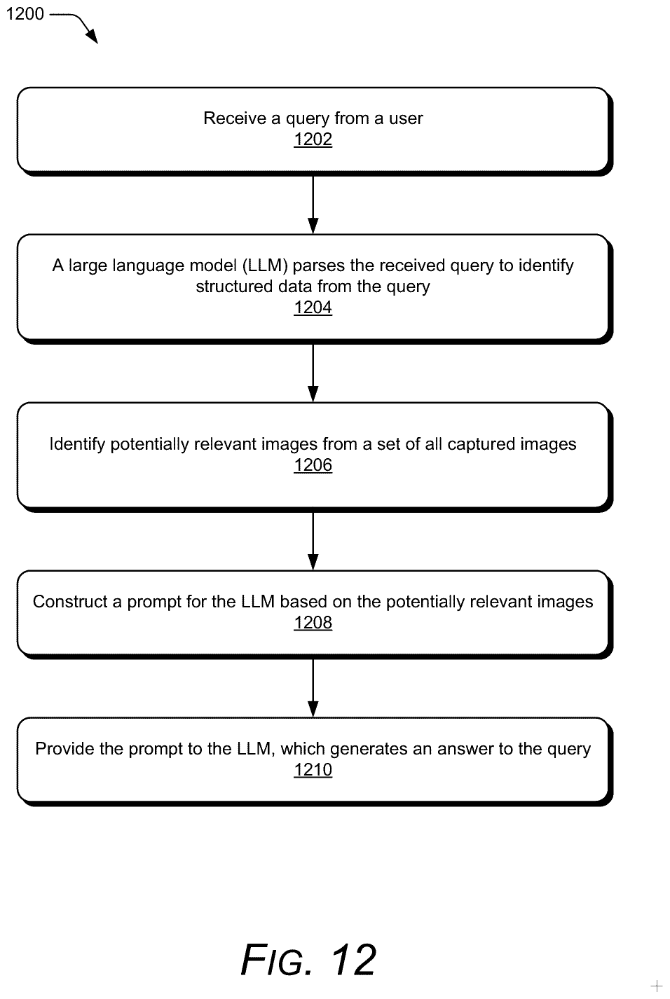

FIG. 12 illustrates an example method 1200 for identifying possible answers to a user query. As discussed herein, the method 1200 may be implemented to assist in creating event summarizations based on a user request using natural language input.

At 1202, the method 1200 receives a query from the user, such as a natural language query requesting creation of an event summarization. For example, the natural language input from the user may be, “What vehicles parked in my driveway today,” “What did my kids do today,” or “Show me animals that were in my back yard last night.”

At 1204, a large language model (LLM) parses the received query to identify structured data from the query. For example, the structured data for the above example query “What vehicles parked in my driveway today” may include:
1. “where: driveway”
2. “devices: front camera”
3. “what: vehicle”
4. “event type: parked vehicle”
5. “time period: today”

At 1206, the method 1200 identifies potentially relevant images from all or most images captured by one or more image capture devices. For example, the potentially relevant images may include:
1. “A red car parked in the driveway”
2. “A delivery van stopped in the driveway”
3. “A small truck parked in the driveway”

At 1208, the method 1200 constructs a prompt for the LLM based on the potentially relevant images. For example, the prompt may include information such as:
1. House has a front camera
2. Watching for vehicles in driveway
3. Examples of possible images captured today

At 1210, the prompt is provided to the LLM, which generates an answer to the query (e.g., identifies images relevant to the event summarization request). In some aspects, the prompt is provided to the LLM along with the specific user query regarding the summarization request (e.g., “What vehicles parked in my driveway today”).

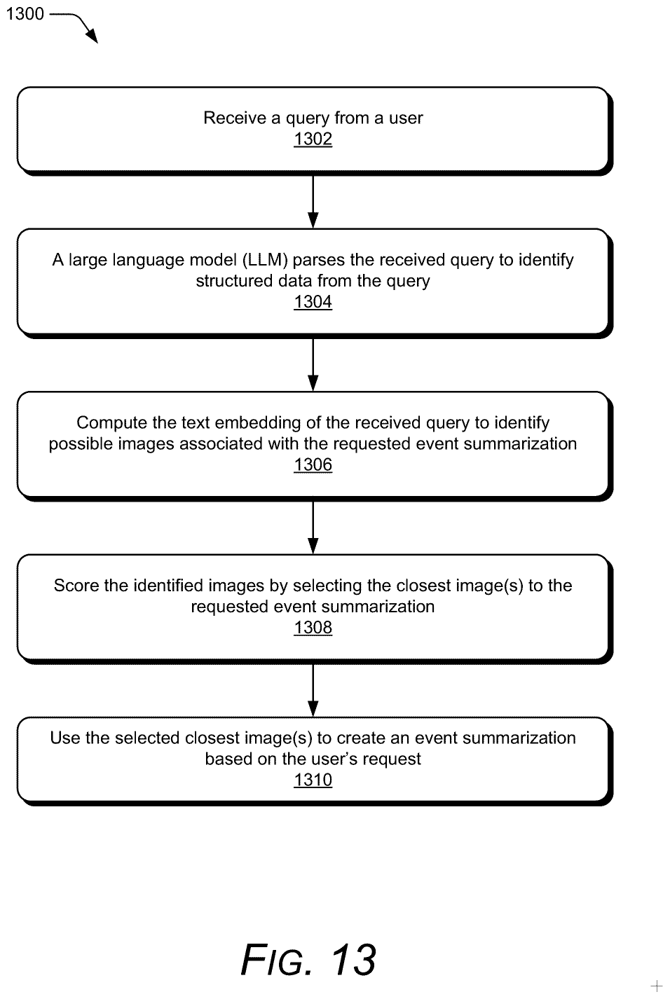

FIG. 13 illustrates an example method 1300 for identifying possible images associated with a user query. The method 1300 may be implemented to assist in summarizing events based on a user request via natural language input.

At 1302, the method 1300 receives a query from the user, such as a natural language query. As discussed herein, the query may request an event summarization based on images captured using one or more image capture devices. Using the example discussed above, the natural language input from the user may be, “What vehicles parked in my driveway today.”

At 1304, a large language model (LLM) parses the received query to identify structured data from the query. For example, the structured data for the above example may include:
1. “where: driveway”
2. “devices: front camera”
3. “what: vehicle”
4. “event type: parked vehicle”
5. “time period: today”

At 1306, the method 1300 computes the text embedding of the received query to identify possible images associated with the requested event summarization. In some aspects, 1306 may include one or more text embedding and image embedding operations as discussed with respect to FIGS. 8 and 9. For example, text embedding model 912 in FIG. 9 generates a text feature vector 914 based on the received query.

At 1308, the method 1300 scores the identified images by selecting the closest image(s) to the received query (e.g., the requested event summarization). In some aspects, selecting the closest image(s) to the received query may use the multimodal embedding system 900 discussed with respect to FIG. 9.

At 1310, the method 1300 uses the selected closest image(s) to create an event summarization based on the user's request.

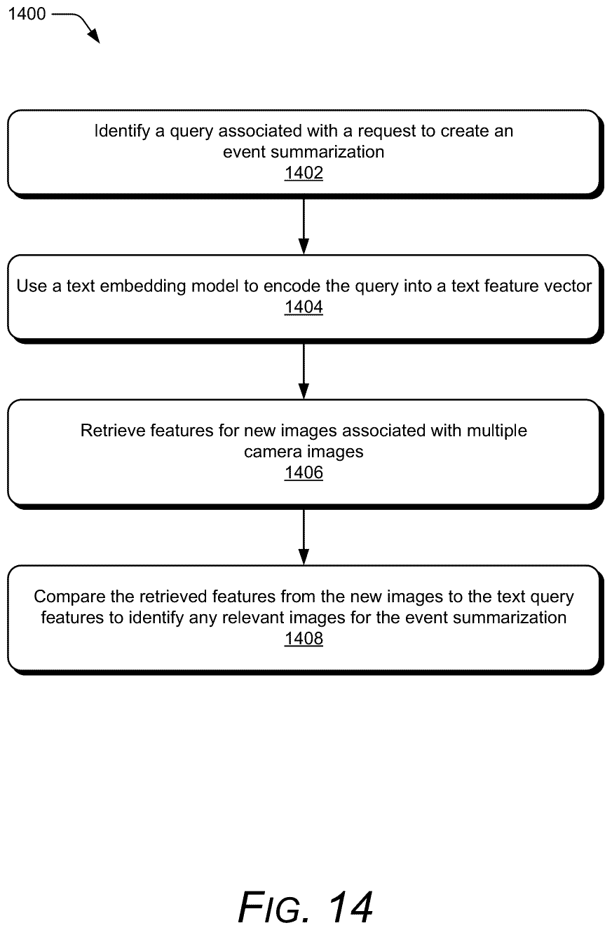

FIG. 14 illustrates an example method 1400 for identifying and responding to a query associated with an event summarization request. As discussed herein, the method 1400 may be implemented to assist in managing the creation of event summarizations based on a natural language query.

At 1402, the method 1400 identifies a query associated with a request to create an event summarization. As discussed herein the query may be a natural language query from a user who wants to receive an event summarization associated with the query.

At 1404, the method 1400 uses a text embedding model to encode the query into a text feature vector. An example text embedding model 912 and text feature vector 914 are discussed herein with respect to FIG. 9.

At 1406, the method 1400 retrieves features for new images associated with multiple camera images. For example, when creating the requested event summarization, the method 1400 may retrieve features as new images are captured by one or more image capture devices. This retrieval of features is further described herein, for example with respect to FIG. 9.

At 1408, the method 1400 compares the retrieved features from the new images to the text query features to identify any relevant images for the event summarization. For example, details associated with a request to create an event summarization may include at least one of an object or an activity. An image may be identified as a relevant image if one or more retrieved features from the image are associated with (for example, indicative of) the object or activity. For example, identifying an image as a relevant image for the event summarization may be based on a comparison of text query features associated with the object or activity to retrieved image features yielding a positive result. In this situation, the image may be considered to satisfy details associated with the request to create the event summarization.

In some embodiments, the systems and techniques described herein may communicate questions or requests for information to a user when creating an event summarization. For example, if the user provides a natural language statement to create a new event summarization, the systems and techniques may have questions about one or more details needed to create the event summarization. In a particular situation, a user may provide a natural language statement to create a new event summarization, such as “Let me know what was in my back yard.” The systems and methods may require additional details regarding what type of “things” should be summarized and what time period should be summarized. In this situation, the described systems and methods may request the user to provide specific details about the types of things to summarize and what time period should be summarized. An example request includes, “Please provide one or more examples of the types of things in your back yard to summarize and the time period to summarize, such as today, yesterday, or this morning.”

In some examples, the systems and methods may communicate with the user creating an event summarization using audio messages, video messages, text messages, email messages, information displayed on a smart home screen, and the like. The user may respond to the communication requesting additional details using any communication technique, such as a natural language statement, an email message, a text message, interacting with a smart home screen, and the like.

After an event summarization has been created, a user may want to repeat the event summarization with the same details or different details. For example, repeating the request, “Let me know what was in my back yard today” will produce different results if the request is repeated on a different day, which has a different date for “today.” In some aspects, a user may repeat the above example event summarization by stating, “repeat the back yard event summarization.”

In some implementations, the described systems and techniques may take a proactive approach by suggesting one or more event summarizations to a user. For example, if the system detects significant activity in the user's front yard, the system may suggest that the user request an event summarization based on activity today in the front yard. Additionally, the systems and techniques may proactively perform the event summarization and communicate the resulting summarization to the user.

Further to the descriptions above, a user may be provided with controls allowing the user to make an election as to both if and when systems, programs, or features described herein may enable collection of user information (e.g., images captured by cameras, such as home cameras, doorbell cameras, queries from a user, and so forth), and if the user is sent or sends content or communications to or from a server. In addition, certain data may be treated in one or more ways before it is stored or used, so that personally identifiable information is removed. For example, a user's identity may be treated so that no personally identifiable information can be determined for the user, such as through obscuring faces or other information in (or metadata for) an image. Thus, the user may have control over what information is collected about the user, how that information is used, and what information is provided to the user.

### EXAMPLES

In the following section, examples are provided.

Example 1: A method comprising:
receiving a request to create an event summarization, wherein the request includes details associated with the event summarization;
identifying at least one image relevant to the event summarization based on the details associated with the event summarization;
selecting, by an event summarization system, at least one of the identified images relevant to the event summarization;
arranging, by the event summarization system, the selected images based on how they will be included in the event summarization; and
creating a video summary representing the event summarization, wherein the video summary includes the arrangement of the selected images.

Example 2: The method of example 1 or any other example, wherein the request to create an event summarization includes at least one of an object to include in the event summarization, an activity to include in the event summarization, a time period associated with the event summarization, or a time limit for the event summarization.

Example 3: The method of example 2 or any other example, wherein arranging the selected images to be included in the event summarization is based on at least one of a chronological order, a particular topic, or a specific theme.

Example 4: The method of example 3 or any other example, wherein a first portion of the selected images are associated with a first camera and a second portion of the selected images are associated with a second camera, and wherein at least one image from the first portion and at least one image from the second portion are included in the video summary.

Example 5: The method of example 4 or any other example, further comprising: identifying at least one missing event summarization detail in the request to create an event summarization; and requesting clarification of the at least one missing event summarization detail.

Example 6: The method of example 5 or any other example, further comprising: determining an event summarization time limit associated with the video summary; determining an image time limit for each image in the video summary; and identifying specific selected images to include in the video summary based on the event summarization time limit and the image time limit.

Example 7: The method of example 6 or any other example, wherein the request to create an event summarization is a natural language request.

Example 8: The method of example 7 or any other example, the method further comprising:
encoding the natural language request using a text embedding model;
creating features associated with the encoded natural language request;
identifying features associated with the identified images;
comparing the identified features of the identified images to the features associated with the encoded natural language request; and
identifying relevant identified images based on the comparison.

Example 9: The method of example 8 or any other example, wherein the features associated with the encoded natural language request and the features of the identified images are stored in a common embedding space.

Example 10: The method of example 9 or any other example, further comprising adjusting an amount of time a particular image is displayed in the video summary based on an importance associated with the particular image.

Example 11: The method of example 10 or any other example, wherein arranging the selected images to be included in the event summarization includes:
adding a first group of images associated with a first topic to the beginning of the event summarization; and
adding a second group of images associated with a second topic to the end of the event summarization.

Example 12: The method of example 11 or any other example, wherein creating the video summary representing the event summarization is performed by an image processing system.

Example 13: The method of example 12 or any other example, further comprising communicating the video summary to at least one system associated with the request to create the event summarization.

Example 14: An apparatus comprising:
an image processing system configured to receive images from an image capture device; and
an event summarization system coupled to the image processing system and configured to:
   receive a request to create an event summarization, wherein the request includes details associated with the event summarization;
   identify at least one image relevant to the event summarization based on the details associated with the event summarization;
   select at least one of the identified images relevant to the event summarization;
   arrange the selected images based on how they will be included in the event summarization; and
   create a video summary representing the event summarization, wherein the video summary includes the arrangement of the selected images.

Example 15: The apparatus of example 14 or any other example, wherein the request to create an event summarization is a natural language request.

Example 16: The apparatus of example 15 or any other example, further comprising a multimodal embedding system including:
a text embedding model configured to encode the natural language request and create features associated with the encoded natural language request; and
an image embedding model configured to:
   encode the identified images;
   create features associated with the encoded identified images;
   compare the identified image features with the natural language request features; and
   identify relevant identified images based on the comparison.

Example 17: The apparatus of example 16 or any other example, wherein the request to create an event summarization includes at least one of an object to include in the event summarization, an activity to include in the event summarization, a time period associated with the event summarization, or a time limit for the event summarization.

Example 18: The apparatus of example 17 or any other example, wherein arranging the selected images to be included in the event summarization is based on at least one of a chronological order, a particular topic, or a specific theme.

Example 19: The apparatus of example 18 or any other example, wherein the event summarization system is further configured to:
determine an event summarization time limit associated with the video summary;
determine an image time limit for each image in the video summary; and
identify specific selected images to include in the video summary based on the event summarization time limit and the image time limit.

Example 20: The apparatus of example 19 or any other example, wherein the event summarization system is further configured to communicate the video summary to at least one system associated with the request to create the event summarization.

### CONCLUSION

While various configurations and methods for implementing event summarization have been described in language specific to features and/or methods, it is to be understood that the subject of the appended claims is not necessarily limited to the specific features or methods described. Rather, the specific features and methods are disclosed as non-limiting examples of implementing event summarization in integrated circuits or other systems.

What is claimed is:

1. A method comprising:
receiving a request to create an event summarization, the request including details associated with the event summarization;
identifying at least one image relevant to the event summarization based on the details associated with the event summarization;
selecting, by an event summarization system, at least one of the identified images relevant to the event summarization;
arranging, by the event summarization system, the selected images; and
creating a video summary representing the event summarization, the video summary including the arrangement of the selected images.

2. The method of claim 1, wherein the request to create an event summarization includes at least one of an object to include in the event summarization, an activity to include in the event summarization, a time period associated with the event summarization, or a time limit for the event summarization.

3. The method of claim 1, wherein arranging the selected images to be included in the event summarization is based on at least one of a chronological order, a particular topic, or a specific theme.

4. The method of claim 1, wherein a first portion of the selected images are associated with a first camera and a second portion of the selected images are associated with a second camera, and wherein at least one image from the first portion and at least one image from the second portion are included in the video summary.

5. The method of claim 1, further comprising:
identifying at least one missing event summarization detail in the request to create an event summarization; and
requesting clarification of the at least one missing event summarization detail.

6. The method of claim 1, further comprising:
determining an event summarization time limit associated with the video summary;
determining an image time limit for each image in the video summary; and
identifying specific selected images to include in the video summary based on the event summarization time limit and the image time limit.

7. The method of claim 1, wherein the request to create an event summarization is a natural language request.

8. The method of claim 7, further comprising:
encoding the natural language request using a text embedding model;
creating features associated with the encoded natural language request;
identifying features associated with the identified images;
comparing the identified features of the identified images to the features associated with the encoded natural language request; and
identifying relevant identified images based on the comparison.

9. The method of claim 8, wherein the features associated with the encoded natural language request and the features of the identified images are stored in a common embedding space.

10. The method of claim 1, further comprising adjusting an amount of time a particular image is displayed in the video summary based on an importance associated with the particular image.

11. The method of claim 1, wherein arranging the selected images to be included in the event summarization includes:
adding a first group of images associated with a first topic to the beginning of the event summarization; and
adding a second group of images associated with a second topic to the end of the event summarization.

12. The method of claim 1, wherein creating the video summary representing the event summarization is performed by an image processing system.

13. The method of claim 1, further comprising communicating the video summary to at least one system associated with the request to create the event summarization.

14. An apparatus comprising:
an image processing system configured to receive images from an image capture device; and
an event summarization system coupled to the image processing system and configured to:
receive a request to create an event summarization, the request including details associated with the event summarization;
identify at least one image relevant to the event summarization based on the details associated with the event summarization;
select at least one of the identified images relevant to the event summarization;
arrange the selected images; and
create a video summary representing the event summarization, the video summary including the arrangement of the selected images.

15. The apparatus of claim 14, wherein the request to create an event summarization is a natural language request.

16. The apparatus of claim 15, further comprising a multimodal embedding system including:
a text embedding model configured to encode the natural language request and create features associated with the encoded natural language request; and
an image embedding model configured to:
encode the identified images;
create features associated with the encoded identified images;
compare the identified image features with the natural language request features; and
identify relevant identified images based on the comparison.

17. The apparatus of claim 14, wherein the request to create an event summarization includes at least one of an object to include in the event summarization, an activity to include in the event summarization, a time period associated with the event summarization, or a time limit for the event summarization.

18. The apparatus of claim 14, wherein arranging the selected images is based on at least one of a chronological order, a particular topic, or a specific theme.

19. The apparatus of claim 14, wherein the event summarization system is further configured to:
determine an event summarization time limit associated with the video summary;
determine an image time limit for each image in the video summary; and
identify specific selected images to include in the video summary based on the event summarization time limit and the image time limit.

20. The apparatus of claim 14, wherein the event summarization system is further configured to communicate the video summary to at least one system associated with the request to create the event summarization.
